(19) United States
(12) Patent Application Publication
(10) Pub. No.: US 2025/0091462 A1
(43) Pub. Date: Mar. 20, 2025

(54) Electric Car Charging Station Device

(71) Applicant: Dan Carter, Winchester, TN (US)

(72) Inventor: Dan Carter, Winchester, TN (US)

(21) Appl. No.: 18/891,420

(22) Filed: Sep. 20, 2024

Related U.S. Application Data
(60) Provisional application No. 63/583,962, filed on Sep. 20, 2023.

(51) Int. Cl. B60L 53/57; B60L 53/10; B60L 53/31; C10L 3/06

(52) U.S. Cl. CPC B60L 53/57; B60L 53/10; B60L 53/31; C10L 3/06

(57) ABSTRACT

An electric vehicle charging device is disclosed that provides users with an economical, natural, and electrical grid-free device to charge an electric vehicle. The electric vehicle charging device is a septic tank gas collection device which harnesses and stores methane gas to power an electrical generator. The device can be used in areas where no power grid is available.

### CROSS-REFERENCE TO RELATED APPLICATION

The present application claims priority to, and the benefit of, U.S. Provisional Application No. 63/583,962, which was filed on Sep. 20, 2023, and is incorporated herein by reference in its entirety.

### FIELD OF THE INVENTION

The present invention relates generally to the field of electric vehicle charging devices. More specifically, the present invention relates to a generator, methane collection, and a device to charge an electric vehicle without external power input. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in electric vehicle charging devices. Generally, people with electric vehicles may be unable to charge the vehicle during a power outage. Widespread blackouts can occur for long periods of time and leave people without a means of traveling if they own an electric vehicle. Further, the scarcity of charging stations can cause travel delays when driving an electric vehicle. Additionally, electric bills can be driven up due to the cost of charging an electric vehicle at home.

Furthermore, installing gas engine/generator assemblies in waste dumps and operating the gas engine with waste dump gas, is well known in the prior art. However, it would be desirable to include using gas collection from a home septic system to provide power to an electric vehicle. For example, it would be desirable to provide power in the event of a grid power outage to charge an electric vehicle. As electric vehicles become more popular, the ability to charge an electric vehicle even when power is not available from the power grid, is needed. Accordingly, using natural methane gas from a septic system to provide fuel to an electric generator can provide the needed electrical power to charge an electric vehicle even in a grid system outage.

Accordingly, there is a demand for an electric vehicle charging device that can charge an electric vehicle even when there is an outage in the power grid. More particularly, the invention provides users with an electric car charging station designed to make charging more energy efficient. Also, the electric vehicle charging device lowers electricity bills when trying to charge electric vehicles, using methane instead of electrical power from the power grid.

Therefore, there exists a long-felt need in the art for an electric vehicle charging device that provides users with a means for charging an electric vehicle that is economical, natural and provides grid-free power. There is also a long-felt need in the art for an electric vehicle charging device that features a means to use natural methane gas from a user's septic system to generate electrical power. Further, there is a long-felt need in the art for an electric vehicle charging device that enables users to charge their electric vehicle even, if there is a power grid outage. Moreover, there is a long-felt need in the art for a device that allows electric vehicle owners a more economical and natural way to charge their electric vehicle. Further, there is a long-felt need in the art for an electric vehicle charging device that prevents any type of loss of the ability to travel, even if there is no power from the power grid to charge the electric vehicle. Finally, there is a long-felt need in the art for an electric vehicle charging device that can be used to power a home in the event of an emergency.

The subject matter disclosed and claimed herein, in one embodiment thereof, comprises an electric vehicle charging device. The device is a multipurpose, economical, natural, and grid-free power device designed to charge an electric vehicle. The electric vehicle charging device comprises a septic tank component that is configured in a rectangular shape with a domed cover. The septic tank component would be a plastic or concrete structure that enables the collection of human waste from a home. The septic tank component also comprises pipes that allow liquid waste to transfer to a drain field or irrigation field. Further, the drain field is topped with half-pipe covers to collect methane gas and transfer the gas to a gas collection tank. Thus, methane gas can be transferred from the gas collection tank to a gas-powered generator to create electrical energy in the event of a power grid outage. The device can also be used to provide power to a house in the event of a power grid outage.

In this manner, the electric vehicle charging device of the present invention accomplishes all of the foregoing objectives and provides users with a device that provides an economical, natural, and electrical grid-free device to charge an electric vehicle. The device is a septic tank gas collection system which harnesses and stores methane gas to power an electrical generator. The device can be used in areas where no power grid is available.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an electric vehicle charging device. The device is a multipurpose, economical, natural, and grid-free power means to charge an electric vehicle. The electric vehicle charging device comprises a septic tank component that is configured in a rectangular shape with a domed cover. The septic tank component would be a plastic or concrete structure that enables the collection of human waste from a home. The septic tank component also comprises pipes that allow liquid waste to transfer to a drain field or irrigation field. Further, the drain field is topped with half-pipe covers to collect methane gas and transfer the gas to a gas collection tank. Thus, methane gas can be transferred from the gas collection tank to a gas-powered generator to create electrical energy in the event of a power grid outage. The device can also be used to provide power to a house in the event of a power grid outage.

In one embodiment, the electric vehicle charging device comprises a septic tank component, a dome component, a shut off valve, multiple vent pipes, multiple half-pipe covers, multiple collection tubes, a gas collection tank, a gas generator, an electric vehicle charging cord, and an EV charging connector. The septic tank component is a generally standard septic tank with the addition of a dome component that covers the top of the septic tank component and allows for the collection of methane gas from the septic tank component. Further, the dome component is sized and shaped to be placed on the top of the septic tank component. Specifically, a bottom side of the dome component is the same size and shape as the tank component and can be releasably secured via bolts, nuts, brackets, etc. The top end of the dome component is semi-spherical in shape and has at least one collection tube positioned in the apex of the dome component. Furthermore, the dome component also covers multiple vent pipes that are commonly placed in a septic tank component to allow methane gas to be vented from the tank component and rise to the apex of the dome component. Then at least one collection tube positioned in the apex of the dome component acts to collect the methane gas that rises from the septic tank component and the methane gas released from the vent pipes, as well. The multiple collection tubes allow the collected methane gas from the vent pipes and septic tank component to be transported into a gas collection tank to be stored. Additionally, the septic tank component and the dome component are both installed below ground level as to be hidden from sight. Typically, the dome component is manufactured from PVC, polycarbonate, aluminum, or any other suitable material as is known in the art.

In one embodiment, the electric vehicle charging device comprises multiple half-pipe covers that cover the drain field of a standard septic system. The drain field positioned beside the septic tank component is designed for capturing the spill over liquid from the septic tank component. Further, the half-pipe covers connect to multiple collection tubes to allow the collected methane gas from the half-pipe covers to be transported into a gas collection tank to be stored. The half-pipe covers are semicircular in shape and are long enough to span the entire drain field of the septic tank component. The half-pipe covers are placed around the top side of the drain field with the open side of the semicircular shape positioned downward. The multiple collection tubes are connected to the half-pipe covers at the upper apex of the semicircular cross section. The collection tubes are connected to the half-pipe covers with screw-in fittings, welded pipe fittings, hose barbs, etc., or any other connection means as is known in the art. Typically, in position, the half pipe covers are placed under the ground level of the drain field. The half-pipe covers are manufactured from PVC, polycarbonate, aluminum, or any other suitable material as is known in the art.

In one embodiment, the multiple collection tubes incorporate at least one check valve to ensure the methane gas only travels in one direction as it is transferred to the gas collection tank. Typically, the collection tubes are manufactured from PVC, polycarbonate, steel, aluminum, or any other suitable material as is known in the art. Further, the collection tubes are approximately between 1″ and 5″ in diameter and are long enough to span the entire drain field and terminate into the gas collection tank.

In one embodiment, the electric vehicle charging device comprises a pump component that is utilized to move the methane gas from the septic tank component (i.e., expelled from the vent pipes) and the half-pipe covers to the gas collection tank. The pump component is placed in line with the collection tubes between the septic tank component, and/or the half-pipe covers and the gas collection tank. The pump component is any suitable pump that is used to move a fluid from one place to another as known in the art. Further, the pump component can be powered by way of solar panels, batteries, electricity from the power grid, etc., or any suitable means as is known in the art.

In one embodiment, the gas collection tank is configured with at least one shut off valve in the collection (input) tubes and the output tubes to the gas-powered generator. The shut off valves can stop methane gas from entering the gas collection tank or exiting to the gas-powered generator, as needed. For example, in the event of an emergency situation, the shut off valves can be closed to prevent accidents or gas leakage. Further, the shut off valves can be electrically operated by a solenoid or manually opened and closed, as needed. Typically, the shut off valves can be a ball valve, plunger valve, door valve, etc., or any other suitable valve as is known in the art.

In one embodiment, the gas generator accepts the methane gas transported from the gas collection tank through the shut off valve via gas supply lines. Typically, the gas generator is any suitable gas generator as is known in the art, that is able to accept methane gas as fuel. The gas generator will convert methane gas into electrical energy that is suitable to charge an electric vehicle. Further, the gas generator allows electrical energy to travel through an electric vehicle charging cord and into the electrical vehicle connector to charge the electric vehicle.

In one embodiment, the gas collection tank is connected to a burner and steam generator. The gas collection tank allows methane gas to travel through the shut off valve and then through pipes to a methane gas burner. In use, the methane gas burner would be positioned below a water tank. When the burner is lit, it will heat the water in the water tank to create steam. The steam is pressurized and allowed to turn a generator to produce electric energy. The electric generator is then connected to an electric vehicle charging cord with an electric vehicle connector to charge the electric vehicle.

In one embodiment, the gas-powered generator or steam generator can be connected to a house to provide electrical power in the event of a power grid outage.

In use, the electric vehicle charging device is assembled by first adding the dome component to a standard septic tank component. When the dome component is attached to the top of the septic tank component, collection tubes are fitted to the apex of the dome component to collect and transport methane gas. Further, half-pipe covers are placed over the drain field and additional collection tubes are fitted to the apex of the half-pipe covers. Methane gas is collected through the collection tubes and transported to the gas collection tank. The gas collection tank is connected to a gas generator capable of using methane gas and turning it into electric energy to charge an electric vehicle.

In one embodiment, the electric vehicle charging device can be utilized with any suitable electric vehicle, as is known in the art.

In yet another embodiment, a method of collecting methane gas and converting it to electrical energy to charge an electric vehicle is disclosed. The method includes the steps of providing an electric vehicle charging device comprising a septic tank component and dome component that are used to collect methane gas from human waste. The method also comprises using vent pipes to transfer methane gas to a plurality of collection tubes from the septic tank component. Further, the method comprises using the half pipe covers over the septic system drain field to transfer methane gas to the plurality of collection tubes. Also, the method comprises transmitting methane gas through multiple check valves to assure that the methane gas travels in one direction. Further, the method comprises collecting the methane gas from the plurality of collection tubes and passing the gas into a gas collection tank to be stored until needed. Finally, the method comprises transferring the collected methane gas to a gas-powered generator to be converted into electric energy to charge an electric vehicle.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a diagram view of one embodiment of the electric vehicle charging device of the present invention showing the device in use in accordance with the disclosed architecture;

FIG. 2 illustrates a detailed view of one embodiment of the electric vehicle charging device of the present invention showing the drain field collection assembly in accordance with the disclosed architecture; and

FIG. 3 illustrates a flowchart showing the method of converting methane gas to electric energy to charge an electric vehicle in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an electric vehicle charging device that provides users with an economical, natural, and grid-free power means which charges electric vehicles. There is also a long-felt need in the art for an electric vehicle charging device that features a means to use natural methane gas from a user's septic system to generate electrical power. Further, there is a long-felt need in the art for an electric vehicle charging device that enables users to charge their electric vehicle even if there is a power grid outage. Moreover, there is a long-felt need in the art for a device that allows electric vehicle owners a more economical and natural way to charge their electric vehicles. Further, there is a long-felt need in the art for an electric vehicle charging device that prevents any type of loss of the ability to travel, even if there is no power from the power grid to charge the electric vehicles. Finally, there is a long-felt need in the art for an electric vehicle charging device that can be used to power a home in the event of an emergency.

The present invention, in one exemplary embodiment, is a novel electric vehicle charging device. The subject matter disclosed and claimed herein, in one embodiment thereof, comprises an electric vehicle charging device. The device is a multipurpose, economical, natural, and grid-free power means to charge an electric vehicle. The electric vehicle charging device comprises a septic tank component that is configured in a rectangular shape with a domed cover. The septic tank component would be a plastic or concrete structure that enables the collection of human waste from a home. The septic tank component also comprises pipes that allow liquid waste to transfer to a drain field or irrigation field. Further, the drain field is topped with half-pipe covers to collect methane gas and transfer the gas to a gas collection tank. Thus, gas can be transferred from the gas collection tank to a gas-powered generator to create electrical energy in the event of a power grid outage. The device can also be used to provide power to a house in the event of a power grid outage.

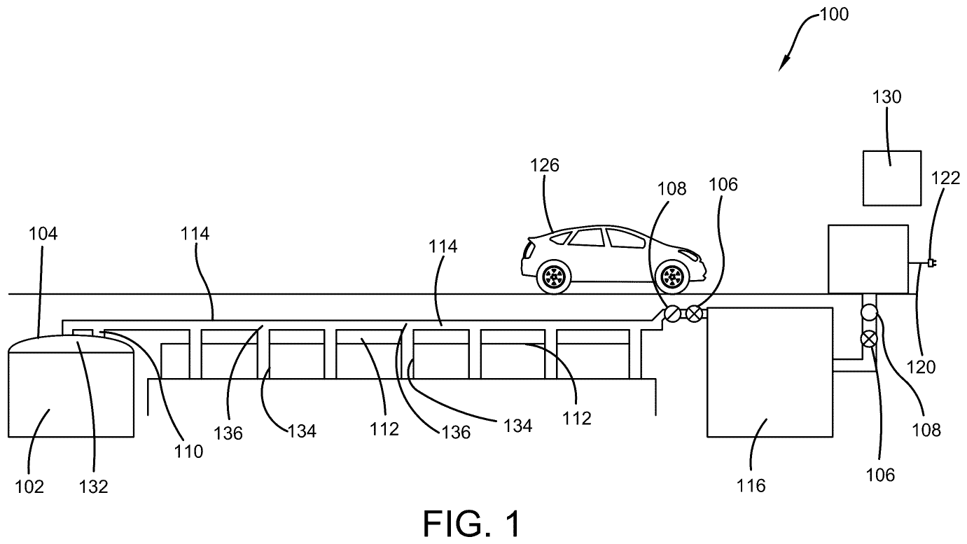

Referring initially to the drawings, FIG. 1 illustrates a diagram view of one embodiment of the electric vehicle charging device 100 of the present invention. In the present embodiment, the electric vehicle charging device 100 is an improved electric vehicle charging device 100 that provides a user with an economical, natural, and grid-free power means to charge electric vehicles 126. Further, the device 100 comprises a septic tank component 102, a dome component 104, a shut off valve 106, a check valve 108, a plurality of vent pipes 110, a plurality of half pipe covers 112, a plurality of collection tubes 114, a gas collection tank 116, a gas-powered generator 118, an electric vehicle charging cord 120, and an EV charging connector 122. Specifically, the electric vehicle charging device 100 comprises a septic tank component 102 that is configured in a rectangular shape with a domed cover 104. The septic tank component 102 would be a plastic or concrete structure that enables the collection of human waste from a home. The septic tank component 102 also comprises standard pipes and other components that allow liquid waste to transfer to a drain field 124 or irrigation field beside the septic tank component 102. Collection tubes 114 positioned within the septic tank component 102 and the drain field 124 collect expelled methane gas and transfer the gas to a gas collection tank 116. The methane gas can then be transferred from the gas collection tank 116 to a gas-powered generator 118 to create electrical energy in the event of a power grid outage. Further, the device 100 can also be used to provide power to a house in the event of a power grid outage.

Generally, the electric vehicle charging device 100 comprises a tank component 102, a dome component 104, and collection tubes 114. The septic tank component 102 is a generally standard septic tank with the addition of a dome component 104 that covers the top of the septic tank component 102 and allows for the collection of methane gas from the septic tank component 102. Further, the dome component 104 is sized and shaped to be placed on the top of the septic tank component 102. Specifically, a bottom side of the dome component 104 is the same size and shape as the septic tank component 102 and can be releasably secured via bolts, nuts, brackets, etc. The top end of the dome component 104 is semi-spherical in shape and has at least one collection tube 114 positioned in the apex 132 of the dome component 104. Furthermore, the dome component 104 also covers multiple vent pipes 110 that are commonly placed in a septic tank component 102 to allow methane gas to be vented from the tank component 102 and rise to the apex 132 of the dome component 104. Then at least one collection tube 114 positioned in the apex 132 of the dome component 104 acts to collect the methane gas that rises from the septic tank component 102 and the methane gas released from the vent pipes 110, as well. The multiple collection tubes 114 allow the collected methane gas from the vent pipes 110 and septic tank component 102 to be transported into a gas collection tank 116 to be stored. Additionally, the septic tank component 102 and the dome component 104 are both installed below ground level, as to be hidden from sight. Typically, the dome component 104 is manufactured from PVC, polycarbonate, aluminum, or any other suitable material as is known in the art.

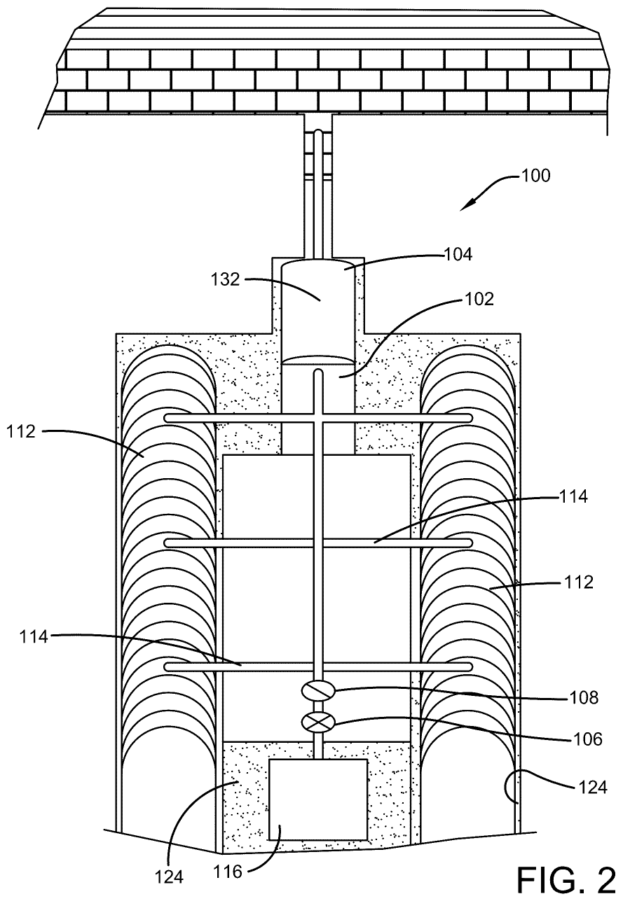

As shown in FIG. 2, the electric vehicle charging device 100 comprises multiple half-pipe covers 112 that cover the drain field 124 of a standard septic system. The drain field 124 positioned beside the septic tank component 102 is designed for capturing the spill over liquid from the septic tank component 102. Further, the half pipe covers 112 connect to multiple collection tubes 114 to allow the collected methane gas from the half pipe covers 112 to be transported into a gas collection tank 116 to be stored. The half-pipe covers 112 are semicircular in shape and are long enough to span the entire drain field 124 of the septic tank component 102. The half-pipe covers 112 are placed around the top side of the drain field 124 with the open side 134 of the semicircular shape positioned downward. The multiple collection tubes 114 are connected to the half-pipe covers 112 at the upper apex 136 of the semicircular cross section. The collection tubes 114 are connected to the half pipe covers 112 with screw-in fittings, welded pipe fittings, hose barbs, etc., or any other connection means as is known in the art. Typically, in position, the half pipe covers 112 are placed under the ground level of the drain field 124. The half-pipe covers 112 are manufactured from PVC, polycarbonate, aluminum, or any other suitable material as is known in the art.

Also, the multiple collection tubes 114 incorporate at least one check valve 108 to assure the methane gas only travels in one direction as it is transferred to the gas collection tank 116. Typically, the collection tubes 114 are manufactured from PVC, polycarbonate, steel, aluminum, or any other suitable material as is known in the art. Further, the collection tubes 114 are approximately between 1″ and 5″ in diameter and are long enough to span the entire drain field 124 and terminate into the gas collection tank 116.

Further, the electric vehicle charging device 100 comprises a pump component 128 that is utilized to move the methane gas from the septic tank component 102 (i.e., expelled from the vent pipes 110) and the half-pipe covers 112 to the gas collection tank 116. The pump component 128 is placed in-line with the collection tubes 114 between the septic tank component 102, and/or the half-pipe covers 112 and the gas collection tank 116. The pump component 128 is any suitable pump that is used to move a fluid from one place to another as known in the art. Further, the pump component 128 can be powered by way of solar panels, batteries, electricity from the power grid, etc., or any suitable means as is known in the art.

Additionally, the gas collection tank 116 is configured with at least one shut off valve 106 in the collection (input) tubes 114 and the output tubes to the gas-powered generator 118. The shut off valves 106 can stop methane gas from entering the gas collection tank 116 or exiting to the gas-powered generator 118, as needed. For example, in the event of an emergency situation, the shut off valves 106 can be closed to prevent accidents or gas leakage. Further, the shut off valves 106 can be electrically operated by a solenoid or manually opened and closed, as needed. Typically, the shut off valves 106 can be a ball valve, plunger valve, door valve, etc., or any other suitable valve as is known in the art.

Furthermore, the gas-powered generator 118 accepts the methane gas transported from the gas collection tank 116 through the shut off valve 106 via gas supply lines. Typically, the gas-powered generator 118 is any suitable gas-powered generator 118 as is known in the art, that is able to accept methane gas as fuel. The gas-powered generator 118 will convert methane gas into electrical energy that is suitable to charge an electric vehicle 126. Further, the gas-powered generator 118 allows electrical energy to travel through an electric vehicle charging cord 120 and into the electrical vehicle charging connector 122 to charge the electric vehicle 126.

In one embodiment, the gas collection tank 116 is connected to a burner and steam generator 130. The gas collection tank 116 allows methane gas to travel through the shut off valve 106 and then through pipes to a methane gas burner 130. In use, the methane gas burner 130 would be positioned below a water tank. When the burner 130 is lit, it will heat the water in the water tank to create steam. The steam is pressurized and allowed to turn a generator to produce electric energy. The electric generator is then connected to an electric vehicle charging cord 120 with an electric vehicle charging connector 122 to charge the electric vehicle 126.

In another embodiment, the gas-powered generator or steam generator 130 can be connected to a house to provide electrical power in the event of a power grid outage.

In use, the electric vehicle charging device 100 is assembled by first adding the dome component 104 to a standard septic tank component 102. When the dome component 104 is attached to the top of the septic tank component 102, collection tubes 114 are fitted to the apex of the dome component 104 to collect and transport methane gas. Further, half-pipe covers 112 are placed over the drain field 124, and additional collection tubes 114 are fitted to the apex of the half-pipe covers 112. Methane gas is collected through the collection tubes 114 and transported to the gas collection tank 116. The gas collection tank 116 is connected to a gas-powered generator 118 capable of using methane gas and turning it into electric energy to charge an electric vehicle 126.

Furthermore, the electric vehicle charging device 100 can be utilized with any suitable electric vehicle 126, as is known in the art.

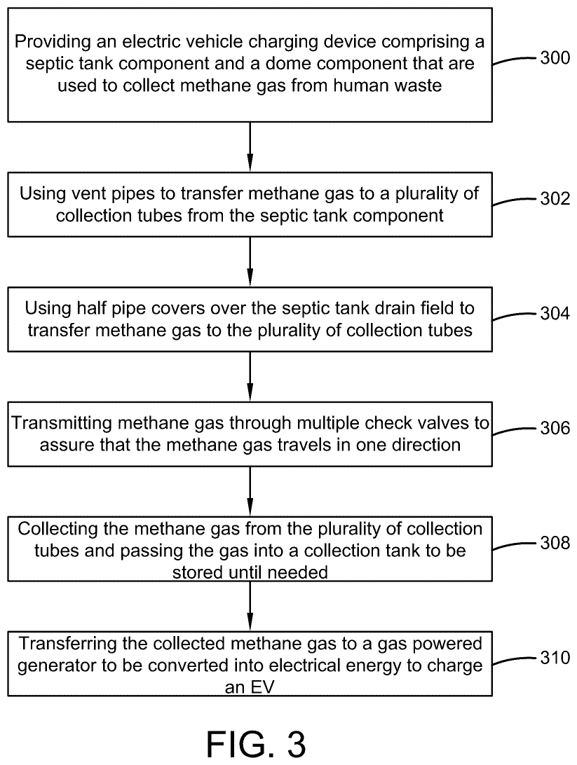

FIG. 3 illustrates a flowchart of the method of collecting methane gas and converting it to electrical energy to charge an electric vehicle. The method includes the steps of at 300, providing an electric vehicle charging device comprising a septic tank component and dome component that are used to collect methane gas from human waste. The method also comprises at 302, using vent pipes to transfer methane gas to a plurality of collection tubes from the septic tank component. Further, the method comprises at 304, using the half pipe covers over the septic system drain field to transfer methane gas to the plurality of collection tubes. Also, the method comprises at 306, transmitting methane gas through multiple check valves to assure that the methane gas travels in one direction. Further, the method comprises at 308, collecting the methane gas from the plurality of collection tubes and passing the gas into a gas collection tank to be stored until needed. Finally, the method comprises at 310, transferring the collected methane gas to a gas-powered generator to be converted into electric energy to charge an electric vehicle.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “electric vehicle charging device”, “charging device”, “electric vehicle device”, and “device” are interchangeable and refer to the electric vehicle charging device 100 of the present invention.

Notwithstanding the foregoing, the electric vehicle charging device 100 of the present invention can be of any suitable size and configuration as is known in the art without affecting the overall concept of the invention, provided that it accomplishes the above-stated objectives. One of ordinary skill in the art will appreciate that the electric vehicle charging device 100 as shown in FIGS. 1-3 is for illustrative purposes only, and that many other sizes and shapes of the electric vehicle charging device 100 are well within the scope of the present disclosure. Although the dimensions of the electric vehicle charging device 100 are important design parameters for user convenience, the electric vehicle charging device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An electric vehicle charging device that provides a user with a grid fee power means to charge electric vehicles, the electric vehicle charging device comprising:
a septic tank component with a dome component;
a plurality of half-pipe covers;
a plurality of collection tubes;
a gas collection tank; and
a gas-powered generator;
wherein the dome component covers the septic tank component;
wherein the plurality of collection tubes are positioned in the dome component to collect methane gas from the septic tank component;
wherein the plurality of half-pipe covers are positioned over a drain field to collect methane gas and transfer it to the plurality of collection tubes;
wherein the plurality of collection tubes transfer methane gas to the gas collection tank; and
further wherein methane gas is transferred from the gas collection tank to a gas-powered generator for conversion to electrical energy to charge an electric vehicle.

2. The electric vehicle charging device of claim 1, wherein the septic tank component is configured in a rectangular shape and is a plastic or concrete structure that enables collection of human waste from a home.

3. The electric vehicle charging device of claim 2, wherein the dome component covers a top of the septic tank component and allows for collection of methane gas from the septic tank component.

4. The electric vehicle charging device of claim 3, wherein a top end of the dome component is semi-spherical in shape and has at least one of the plurality of collection tubes positioned in an apex of the dome component.

5. The electric vehicle charging device of claim 4, wherein the dome component covers multiple vent pipes that are placed in the septic tank component to vent methane gas.

6. The electric vehicle charging device of claim 5, wherein the plurality of collection tubes positioned in the dome component acts to collect the methane gas that rises from the septic tank component and the methane gas released from the multiple vent pipes.

7. The electric vehicle charging device of claim 6, wherein the plurality of collection tubes transport methane gas into the gas collection tank to be stored.

8. The electric vehicle charging device of claim 7, wherein the plurality of half pipe covers are semicircular in shape and are long enough to span an entire drain field of the septic tank component.

9. The electric vehicle charging device of claim 8, wherein the plurality of half pipe covers are placed around a top side of the drain field with an open side of the semicircular shape positioned downward.

10. The electric vehicle charging device of claim 9, wherein the plurality of collection tubes are connected to the plurality of half pipe covers at an upper apex of the semicircular cross section.

11. The electric vehicle charging device of claim 10, wherein the plurality of collection tubes incorporate at least one check valve to assure the methane gas only travels in one direction as it is transferred to the gas collection tank.

12. The electric vehicle charging device of claim 11, wherein a pump component is utilized to move the methane gas from the septic tank component and the plurality of half pipe covers to the gas collection tank.

13. An electric vehicle charging device that provides a user with a grid fee power means to charge electric vehicles, the electric vehicle charging device comprising:
a septic tank component with a dome component;
a plurality of half-pipe covers;
a plurality of collection tubes;
a gas collection tank; and
a gas-powered generator;
wherein the dome component covers a top of the septic tank component and allows for collection of methane gas from the septic tank component;
wherein a top end of the dome component is semi-spherical in shape and has at least one of the plurality of collection tubes positioned in an apex of the dome component;
wherein the plurality of collection tubes are positioned in the dome component to collect methane gas from the septic tank component;
wherein the dome component covers multiple vent pipes that are placed in the septic tank component to vent methane gas;
wherein the plurality of half-pipe covers are positioned over a drain field to collect methane gas and transfer it to the plurality of collection tubes;
wherein the plurality of half pipe covers are semicircular in shape and are long enough to span an entire drain field of the septic tank component;
wherein the plurality of half pipe covers are placed around a top side of the drain field with an open side of the semicircular shape positioned downward;
wherein the plurality of collection tubes transfer methane gas to the gas collection tank to be stored;
wherein the plurality of collection tubes incorporate at least one check valve to assure the methane gas only travels in one direction as it is transferred to the gas collection tank; and
further wherein methane gas is transferred from the gas collection tank to a gas-powered generator for conversion to electrical energy to charge an electric vehicle.

14. The electric vehicle charging device of claim 13, wherein a pump component is utilized to move the methane gas from the septic tank component and the plurality of half pipe covers to the gas collection tank.

15. The electric vehicle charging device of claim 14, wherein the pump component is placed in-line with the plurality of collection tubes between the septic tank component and the plurality of half pipe covers and the gas collection tank.

16. The electric vehicle charging device of claim 13, wherein the gas collection tank is configured with at least one shut off valve in the plurality of collection tubes and output tubes to the gas-powered generator.

17. The electric vehicle charging device of claim 16, wherein the gas-powered generator accepts the methane gas transported from the gas collection tank through the at least one shut off valve via gas supply lines and converts the methane gas to electrical energy.

18. The electric vehicle charging device of claim 17, wherein the gas-powered generator allows electrical energy to travel through an electric vehicle charging cord and into an electrical vehicle charging connector to charge the electric vehicle.

19. The electric vehicle charging device of claim 13, wherein the gas collection tank is connected to a burner and steam generator to produce electric energy and then connected to a house to provide electrical power in the event of a power grid outage.

20. A method of collecting methane gas and converting it to electrical energy to charge an electric vehicle, the method comprising the following steps:
providing an electric vehicle charging device comprising a septic tank component and a dome component that are used to collect methane gas from human waste;
using vent pipes to transfer methane gas to a plurality of collection tubes from the septic tank component;
using the half pipe covers over the septic system drain field to transfer methane gas to the plurality of collection tubes;
transmitting methane gas through multiple check valves to assure that the methane gas travels in one direction;
collecting the methane gas from the plurality of collection tubes and passing the gas into a gas collection tank to be stored until needed; and
transferring the collected methane gas to a gas-powered generator to be converted into electric energy to charge an electric vehicle.
